(19) United States
(12) Patent Application Publication
(10) Pub. No.: US 2005/0122430 A1
(43) Pub. Date: Jun. 9, 2005

(54) Image storing/replaying apparatus and method therefor

(75) Inventors: Jung-won Lee, Ansan-si (KR); Tae-hee Kim, Seoul (KR); Sang-yun Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/975,381

(22) Filed: Oct. 29, 2004

(30) Foreign Application Priority Data
Dec. 5, 2003 (KR) 2003-87941

(51) Int. Cl. H04N 5/44

(52) U.S. Cl. 348/559

(57) ABSTRACT

An image storing and/or replaying apparatus and a method therefor capable of storing a transient image and replaying the stored image at a desired time, the apparatus receives a broadcast stream including a plurality of still image frames and replays the images on a screen. The apparatus includes an image unit, which extracts and stores at least a portion of the plurality of the still image frames and replays the stored still image frames; and a control unit, which controls the extracting, storing, and replaying operations. The apparatus can be adapted to digital and analog broadcasts. In addition, in case of the digital broadcast, an I-frame may be extracted from a compressed image frame and stored. In particular, only some portion of the I-frame, that is, a lower slice of the I-frame, may be stored.

### CROSS-REFERENCE TO RELATED APPLICATIONS

This application claims the benefit of Korean Patent Application No. 2003-87941, filed on Dec. 5, 2003 in the Korean Intellectual Property Office, the disclosure of which is incorporated herein by reference.

### BACKGROUND OF THE INVENTION

1. Field of the Invention

The present invention relates to an apparatus receiving and processing a broadcast image and a method therefor, and more particularly, to an image storing and/or replaying apparatus and a method therefor capable of conveniently viewing a past caption by storing a predetermined portion of an image including a caption and replaying the stored image at a desired time.

2. Description of the Related Art

FIG. 1A illustrates a block diagram of a conventional digital broadcast receiver. The conventional digital broadcast receiver includes a tuner unit 10, a transport stream parsing unit 11, an A/V decoder 12, a TV screen 13, and a speaker 14. If a broadcast channel is selected by the tuner unit 10, a broadcast stream is received. The transport stream parsing unit 11 separates image transfer packets and voice transfer packets from 188-byte transfer packets constituting the broadcast stream of the selected broadcast channel. The A/V decoder 12 decodes and outputs the image and voice transfer packets to the TV screen 13 and the speaker 14, respectively.

The broadcast stream is an image signal compressed in accordance with a compression scheme such as an MPEG-2 scheme. The compressed image signal includes I-frames, P-frames, and B-frames. The I-frame is a frame capable of randomly accessing data without referring to the other frames. The I-frame is a frame including entire information upon which the reproducing apparatus can reproduce an image of a frame without any information of another frame. The I-frame is compressed using a JPEG compression scheme, that is, a still image compression scheme. The P-frame is a frame compressed by encoding a minute change of a current frame from preceding I-frame or P-frame. The B-frame is a frame compressed by referring to the foregoing and following I-frame and P-frame. Therefore, the B-frame and I-frame have the highest and lowest compression rates, respectively.

FIG. 2 is a conceptual view explaining compression and decompression of an original image including 8 frames F1 to F8. When the original image is compressed, the P-frame refers to the preceding I-frame or P-frame, and the B-frame refers to the preceding and following I-frame or P-frame. Therefore, the original image is encoded in a sequence of F1, F2, F5, F3, F4, F8, F6, and F7. On the other hand, in order to obtain a decompressed image, the encoded, compressed image is decoded in the same sequence.

On the other hand, the digital broadcast receiver may further include a storage medium such as a hard disk drive storing the broadcast stream in order to function as a personal video recorder (PVR). In addition, the digital broadcast receiver may be implemented in a form of a set-top box separate from a TV set. Otherwise, the digital broadcast receiver may be built in the TV set.

FIG. 1B illustrates a block diagram of a conventional digital broadcast receiver. The conventional analog broadcast receiver includes a tuner unit 20, a broadcast signal processing unit 21, an amplifier unit 22, a TV screen 23, and a speaker 24. If the tuner unit 20 selects a broadcast channel, a broadcast signal is received. The broadcast signal processing unit 21 performs intermediate frequency amplification on an image and voice of an output signal of the tuner unit 20 to separate the image signal from the voice signal. The amplifier unit 22 amplifies and outputs the separated image and voice signals to the TV screen 23 and the speaker 24, respectively.

The conventional digital and analog broadcast receivers have a problem in that the images broadcasted in real time cannot be stored. In particular, as the scene changes, the text displayed as a caption is erased. Therefore, a viewer must memorize or write down the text if desired.

In addition, if text transiently displayed on the caption has a large amount of information, it is difficult for the viewer to completely memorize or write down the information.

### SUMMARY OF THE INVENTION

According to an aspect of the present invention, there is provided an image storing and/or replaying apparatus and a method therefor capable of conveniently viewing a past image by storing a broadcast image and replaying the stored image at a desired time.

According to an aspect of the present invention, there is provided an image storing and/or replaying apparatus and a method therefor capable of conveniently viewing a past caption by storing a predetermined portion of an image including a caption and replaying the stored image at a desired time.

According to an aspect of the present invention, there is provided an image storing and/or replaying apparatus receiving a broadcast stream having a plurality of still image frames and replaying an image on a screen, the apparatus including: an image unit, which extracts and stores at least a portion of the plurality of the still image frames and replays the stored still image frames; and a control unit, which controls the extracting, storing, and replaying operations.

According to an aspect of the present invention, in the image storing and/or replaying apparatus, the broadcast stream may be a digital broadcast stream, and the image unit may include: a still image extracting unit, which extracts at least a portion of the plurality of the still image frames; and a still image storing unit, which stores the extracted still image frames. The image storing and/or replaying apparatus may further include a codex unit, which encodes the extracted still image frames in accordance with a predetermined compression scheme, and the still image storing unit may store the encoded still image frames.

In the image storing and/or replaying apparatus, the codex unit may decompress the encoded still image frames stored in the still image storing unit in response to an external input signal indicating replaying the stored still image frames.

In the image storing and/or replaying apparatus, the broadcast stream may be an analog broadcast stream, and the image unit may include: an image extracting unit, which extracts at least a portion of the plurality of the still image frames; an A/D converter, which converts the extracted analog still image frames into digital still image frames; an encoder, which compresses the digital still image frames in accordance with a predetermined still image compression scheme; a memory, which stores the compressed digital still image frame; a decoder, which decompresses the digital still image frames stored in the memory; and a D/A converter, which converts the decompressed digital still image frames into analog still image frames.

According to an aspect of the present invention, in the image storing and/or replaying apparatus, the image unit may extract a portion of data from at least a portion of frames of the plurality of the still image frames. In the image storing and/or replaying apparatus, the extracting operation may be performed at a predetermined time interval. In the image storing and/or replaying apparatus, the control unit may control the replayed still image frames to be scrolled and displayed on the screen.

According to an aspect of the present invention, there is provided an image storing and/or replaying apparatus receiving a broadcast stream having a plurality of compressed image frames including I-frames, P-frames, and B-frames and replaying an image on a screen, the apparatus including: an I-frame extracting unit, which extracts at least a portion of I-frames of the compressed image frames; an I-frame storing unit, which stores the extracted I-frames; a decoding unit, which decodes the stored I-frames in accordance with a predetermined decoding scheme to replay the I-frame; and a control unit, which controls the extracting, storing, and replaying operations.

According to an aspect of the present invention, in the image storing and/or replaying apparatus, the I-frame extracting unit may extract the at least a portion of the I-frames at a predetermined time interval. In the image storing and/or replaying apparatus, the I-frame extracting unit may extract a portion of data in the I-frames.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate block diagrams of conventional digital and analog broadcast receivers;

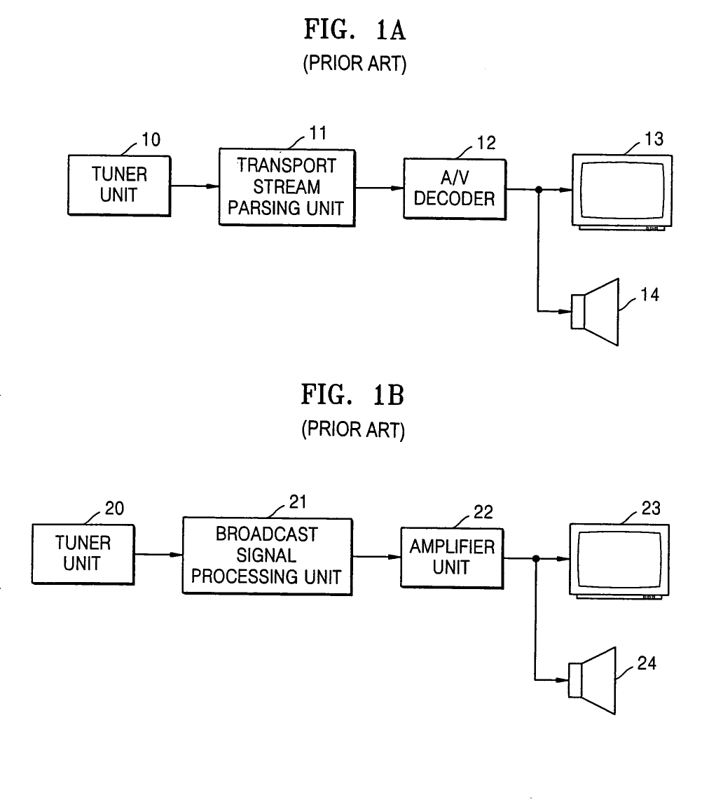

FIG. 2 is a view explaining compression and decompression of a digital image signal;

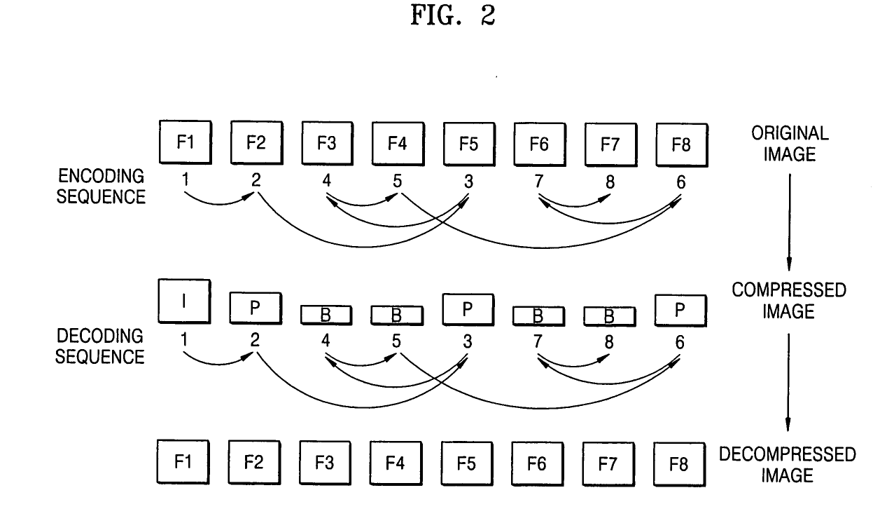

FIG. 3 illustrates a block diagram of a digital broadcast receiver according to an embodiment of the present invention;

FIG. 4 illustrates a block diagram of an analog broadcast receiver according to an embodiment of the present invention;

FIG. 5 illustrates a block diagram of a digital broadcast receiver according to another embodiment of the present invention;

FIG. 6 illustrates flowcharts of a broadcast image storing and/or replaying method according to an embodiment of the present invention; and

FIG. 7 illustrates flowcharts of a broadcast image storing and/or replaying method according to still another embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

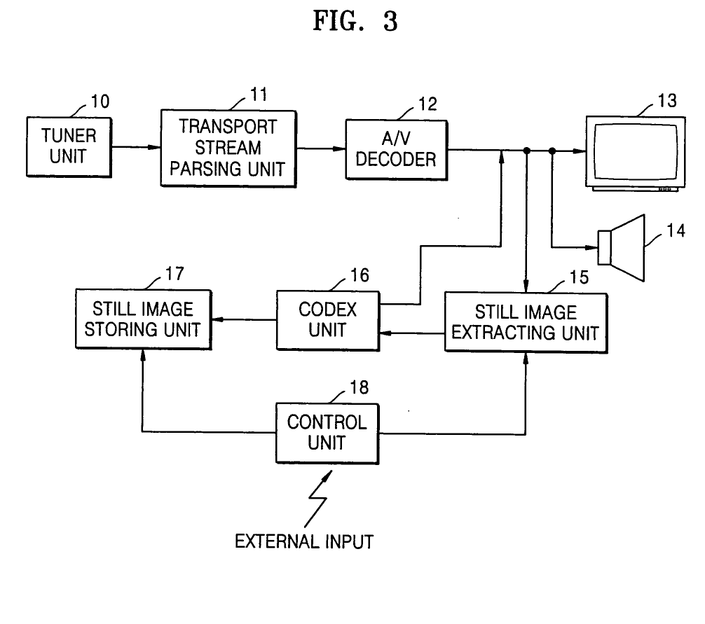

FIG. 3 illustrates a block diagram of a digital broadcast receiver according to an embodiment of the present invention. The digital broadcast receiver includes a tuner unit 10, a transport stream parsing unit 11, an A/V decoder 12, a TV screen 13, a speaker 14, a still image extracting unit 15, a codex unit 16, a still image storing unit 17, and a control unit 18. Since the tuner unit 10, the transport stream parsing unit 11 and the A/V decoder 12 have the same structures and function as conventional ones, their description is omitted. The still image extracting unit 15, the codex unit 16, and the still image storing unit 17 constitute the image unit.

The still image extracting unit 15 extracts frames from an image decoded by the A/V decoder 12 and outputs the extracted frames to the codex unit 16. The codex unit 16 compresses the extracted frames in accordance with a predetermined still image compression scheme such as the JPEG scheme. The still image storing unit 17 stores the compressed image frames. The control unit 18 controls the extracting, storing, and replying operations on the still image. On the other hand, the codex unit 16 is needed to store a great amount of all decoded frames of the original image output from the decoder 12. Therefore, if there is a sufficient storage space, the codex unit 16 may be omitted.

Now, the operation of the digital broadcast receiver according to the embodiment of the present invention will be described. The control unit 18 operates in response to commands input via an external input unit (not show) such as a function button panel and a remote control input device by a user. When the user inputs a still image storing command, the control unit 18 controls the still image extracting unit 15 to extract the still image frames output from the A/V decoder 12.

The user may input time information such as a storing time period, a storing starting time, and a storing ending time in addition to the still image storing command. The control unit 18 controls the extracting interval of the still image extracting unit 15 based on the time information. If the user does not input the time information, the time period may be set to a default value. In most cases, captions are displayed at a lower portion of a TV screen 13. Therefore, only the lower portion of the frames output from A/V decoder 12 may be extracted. In some cases, another portion of the frames may be extracted in response to an external input.

In response to a command of the control unit 18, the still image extracting unit 15 extracts still image frames from the original image and outputs the extracted still image frames to the codex unit 16. The codex unit 16 compresses the extracted still image frames in accordance with a predetermined still image compression scheme and stores the compressed still image frames in the still image storing unit 17. On the other hand, if the to-be-stored still image frames exceed the storage capacity of the still image storing unit 17, some of the stored still image frames are removed in a “first store first remove” manner.

When the user inputs a replay command to the control unit 18, the control unit 18 controls the still image storing unit 17 to output the stored still image frames to the codex unit 16. The codex unit 16 decodes the compressed still image frame and outputs the decoded still image frame to the TV screen 13. The control unit 18 controls the replayed still image frames to be scrolled on the TV screen 13, so that the user can easily view the stored still image frames.

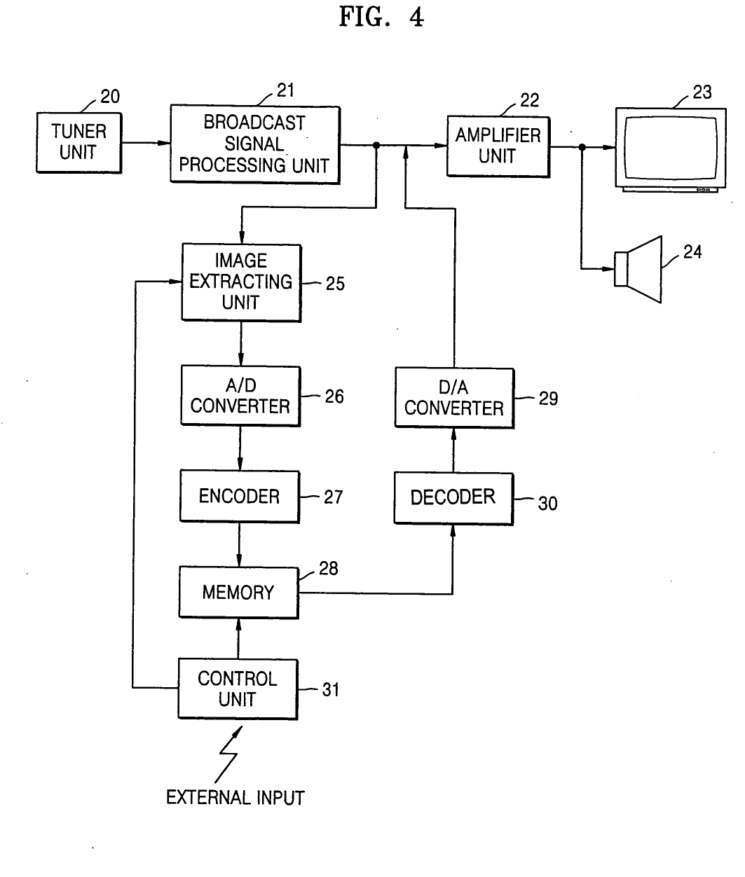

FIG. 4 illustrates a block diagram of an analog broadcast receiver according to an embodiment of the present invention. The analog broadcast receiver includes a tuner unit 20, a broadcast signal processing unit 21, an amplifier unit 22, a TV screen 23, a speaker 24, an image extracting unit 25, an A/D converter 26, an encoder 27, a memory 28, a D/A converter 29, a decoder 30, and a control unit 31. Since the tuner unit 20, the broadcast signal processing unit 21, and the amplifier unit 22 in the embodiment have the same structures and function as conventional ones, their description is omitted. The image extracting unit 25, the A/D converter 26, the encoder 27, the memory 28, the D/A converter 29, and the decoder 30 constitute still image storing means or the image unit.

The analog broadcast receiver according to the embodiment of the present invention basically has the same structure as the digital broadcast receiver of FIG. 3. When time information such as an extracting time interval is input to the control unit 31, the image extracting unit 25 detects image signals to extract an image with a predetermined time interval in response to a command of the control unit 31. Similar to the digital broadcast image, the analog broadcast image includes a plurality of still images. In the below description, a frame refers to a still image as a unit of the analog broadcast image as well as the digital broadcast image.

The extracted image is constituted with analog signals. The A/D converter 26 converts the analog signals to digital signals constituting the digital image. The converted still image frame is encoded in a predetermined compression scheme by the encoder 27 and stored in the memory 28. Even in this case, the control unit 31 may control the image extracting unit 25 to extract some portion of the still image frame. On the other hand, in response to a replay command for replaying the still images stored in the memory 28, the control unit 31 controls the memory 28 to output the still image. The output still images are decoded by the decoder 30 and converted to analog signals by the D/A converter 29. The analog signals are output to the amplifier 22.

In addition, the image extracting scheme and the replaying scheme applied to the digital broadcast receiver of FIG. 3 can be applied to the analog broadcast receiver of FIG. 4.

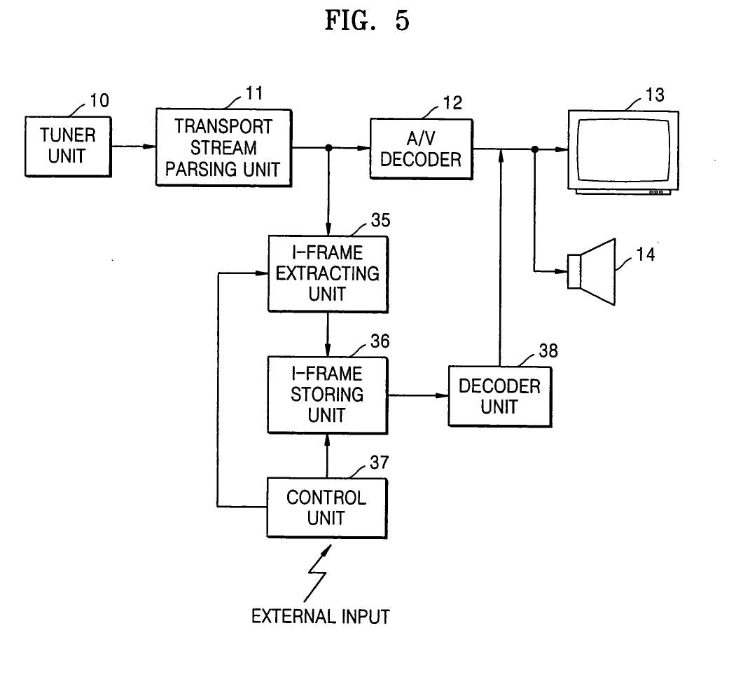

FIG. 5 illustrates a block diagram of a digital broadcast receiver according to another embodiment of the present invention. The digital broadcast receiver includes a tuner unit 10, a transport stream parsing unit 11, an A/V decoder 12, a TV screen 13, a speaker 14, an I-frame extracting unit 35, an I-frame storing unit 36, a control unit 37, and a decoder 38.

Although the digital broadcast receiver of FIG. 3 extracts the image processed by the A/V decoder 12, the digital broadcast receiver according to the embodiment extracts only the I-frame from the compressed image which is not processed by the A/V decoder 12. In principle, two or more compressed images are contained in the I-frames per second, and the caption resides on a screen for one or more seconds. The digital broadcast receiver according to the embodiment is implemented as follows.

In addition, since the P-frame or B-frame refers to other I-frames and/or P-frames in order to decompress the still image, it is of no use to extract the P-frame or B-frame which is not processed by the A/V decoder 12.

In response to a command of the control unit 37, the I-frame extracting unit 35 extracts only the I-frame from the compressed image separated by the transport stream parsing unit 11 within a predetermined extracting time interval. In this case, an external input signal may include a still image extracting command and information about the extracting time interval, etc. In addition, at the set time, if the frame output from the transport stream parsing unit 11 is not an I-frame, the I-frame extracting unit 35 extracts an I-frame output at the nearest time.

The I-frame storing unit 36 stores the I-frame output from the I-frame extracting unit 35, and outputs the stored I-frame to the decoder 38 in response to the replay command of the control unit 37. The decoder 38 decodes the compressed I-frame in accordance with the same compression scheme as the predetermined compression scheme such as the JPEG compression scheme, and outputs the decoded I-frame on the TV screen.

Now, operations of a digital broadcast receiver according to another embodiment of the present invention will be described. When a user inputs a still image storing command and a storing time interval, etc., using an external input unit (not shown), the control unit 37 controls an extracting operation for extracting I-frame output from a transport stream parsing unit 11 with a predetermined extracting time interval. The controller 37 may control an extracting operation for extracting some portion of the I-frame, for example, a lower slice of the I-frame. As a result, it is possible to view not the entire image but the caption thereof, if desired.

The I-frames extracted by the I-frame extracting unit 35 are stored in the I-frame storing unit 36. In response to a command from the control unit 37, the stored I-frames are output to the decoder 38, and the stored I-frame is displayed on the TV screen 13. The control unit 37 controls the I-frame to be scrolled on the TV screen 13, so that the user can conveniently view the still image or the caption.

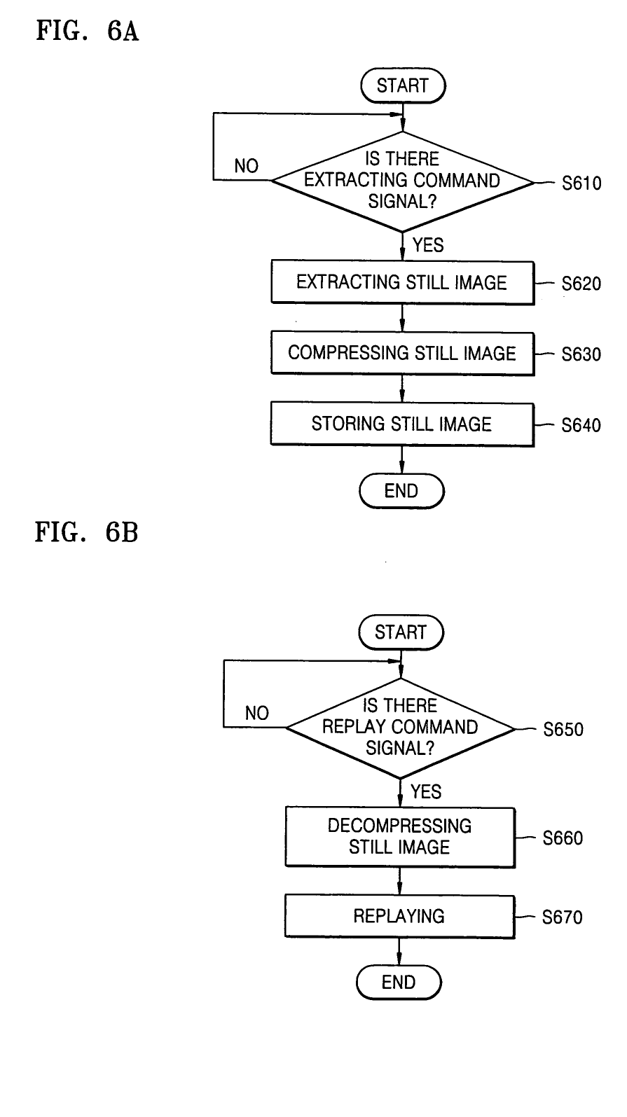

FIGS. 6A and 6B illustrate flowcharts of a broadcast image storing and/or replaying method according to an embodiment of the present invention Firstly, FIG. 6A is a flowchart illustrating operations of extracting and storing a still image frame. In operation S610, it is determined that an external extracting start signal is input. If the signal is input, the procedure proceeds to operation S620 of extracting the still image frame with a predetermined extracting time interval which is input together with the extracting start signal. In operation 630, the extracted still image frame is compressed in accordance with a predetermined still image compression scheme such as a JPEG compression scheme. In operation 640, the compressed still image frame is stored.

FIG. 6B is a flowchart illustrating operations of decompressing and replaying the stored still image frame. In operation S650, it is determined whether an external replay signal is input. If the signal is input, the procedure proceeds to operation S660 of decompressing the compressed still image frame in accordance with the same scheme as the still image compression scheme. In operation 670, the decompressed still image frame is displayed on the TV screen 13.

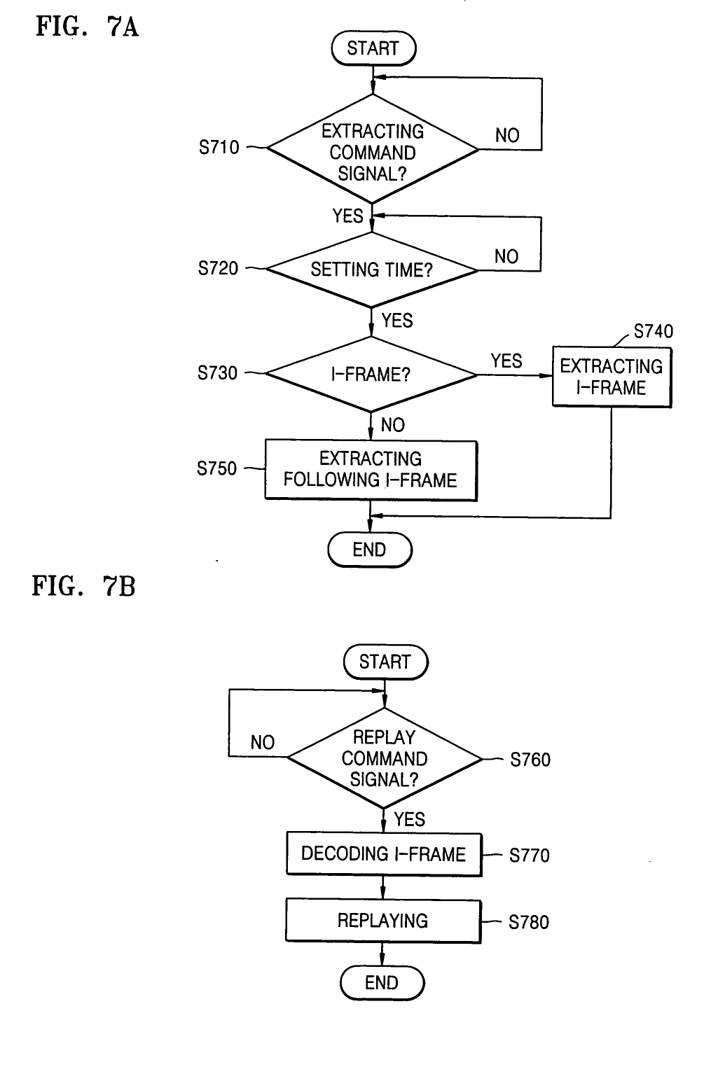

FIGS. 7A and 7B illustrate flowcharts of an I-frame storing and/or replaying method in a digital broadcast receiver according to another embodiment of the present invention.

FIG. 7A is a flowchart illustrating operations of extracting and storing the I-frame. In operation S710, it is determined whether an external extracting start signal is input. If the signal is input, the procedure proceeds to operation S720 of determining whether or not it is the set time input together with the extracting start signal. If it is the set time, the procedure proceeds to operation 730. In operation 730, it is determined whether or not the compressed image frame output from the transport stream parsing unit 11 at the set time is an I-frame. If the compressed image frame is the I-frame, the I-frame is extracted in operation 740. If not, in operation 750, the I-frame occurring at the nearest time is extracted.

FIG. 7B is a flowchart illustrating operations of replaying the stored I-frame. In operation S760, it is determined whether an external replay signal is input. If the signal is input, the procedure proceeds to operation S770 of decoding the stored I-frame. The decoded I-frame is replayed in operation 780.

According to the present invention, since a broadcast image is stored and the stored image is replayed at a desired time, it is possible to conveniently view a past image.

In addition, according to the present invention, since a predetermined portion of an image including a caption is stored and the stored image is replayed at a desired time, it is possible to conveniently view a past caption.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image storing and/or replaying apparatus receiving a broadcast stream having a plurality of still image frames and replaying an image on a screen, the apparatus comprising:
an image unit which extracts and stores at least one of the plurality of the still image frames and replays the stored at least one of the plurality of the still image frames; and
a control unit, which controls the extracting, storing, and replaying.

2. The image storing and/or replaying apparatus according to claim 1,
wherein the broadcast stream is a digital broadcast stream, and
wherein the image unit comprises:
a still image extracting unit which extracts the at least one of the plurality of the still image frames; and a still image storing unit which stores the extracted at least one of the plurality of the still image frames.

3. The image storing and/or replaying apparatus according to claim 2,
wherein the apparatus further comprises a codex unit, which encodes the extracted at least one of the plurality of the still image frames in accordance with a predetermined compression scheme; and
wherein the still image storing unit stores the encoded at least one of the plurality of the still image frames.

4. The image storing and/or replaying apparatus according to claim 3, wherein the codex unit decompresses the encoded at least one of the plurality of the still image frames stored in the still image storing unit in response to an external input signal indicating replaying of the stored at least one of the plurality of the still image frames.

5. The image storing and/or replaying apparatus according to claim 1,
wherein the broadcast stream is an analog broadcast stream, and
wherein the still image unit comprises:
an image extracting unit which extracts at least one analog still image frame from the plurality of still image frames;
an A/D converter which converts the extracted at least one of the analog still image frames into digital still image frames;
an encoder which compresses the digital still image frames in accordance with a predetermined still image compression scheme;
a memory, which stores the compressed digital still image frames;
a decoder, which decompresses the stored digital still image frames stored in the memory; and
a D/A converter, which converts the decompressed digital still image frames into the at least one analog still image frame.

6. The image storing and/or replaying apparatus according to claim 1, wherein the image unit extracts and stores a portion of data from the at least one of the plurality of the still image frames.

7. The image storing and/or replaying apparatus according to claim 1, wherein the extracting is performed at a predetermined time interval.

8. The image storing and/or replaying apparatus according to claim 1, wherein the control unit controls the replayed still image frames to be scrolled and displayed on the screen.

9. An image storing and/or replaying apparatus receiving a broadcast stream having a plurality of compressed image frames including I-frames, P-frames, and B-frames and replaying an image on a screen, the apparatus comprising:
an I-frame extracting unit which extracts at least a portion of the I-frames of the compressed image frames;
an I-frame storing unit which stores the extracted I-frames;
a decoding unit which decodes the stored I-frames in accordance with a predetermined decoding scheme to replay the decoded I-frame; and
a control unit which controls the extracting, storing, and replaying.

10. The image storing and/or replaying apparatus according to claim 9, wherein the I-frame extracting unit extracts the I-frames at a predetermined time interval.

11. The image storing and/or replaying apparatus according to claim 9, wherein the I-frame extracting unit extracts the I-frames.

12. An image storing and/or replaying method receiving a broadcast stream having a plurality of still image frames and replaying an image on a screen, the method comprising:
extracting at least one of the plurality of the still image frames;
storing the extracted at least one of the plurality of the still image frames; and
replaying the stored at least one of the plurality of the still image frames,
wherein the extracting, storing, and replaying are performed in response to an external input signal.

13. The method according to claim 12,
wherein the broadcast stream is a digital broadcast stream, and
wherein, in the storing, the extracted at least one of the plurality of the still image frames is compressed in accordance with a predetermined compression scheme.

14. The method according to claim 13, wherein, in the replaying, the compressed at least one of the plurality of the still image frames is decoded in accordance with the predetermined compression scheme.

15. The method according to claim 12,
wherein the broadcast stream is an analog broadcast stream, and
wherein the storing comprises:
converting extracted analog still image frames into digital still image frames; and
compressing the digital still image frames with a predetermined compression scheme and storing the digital still image frames.

16. The method according to claim 15, wherein the replaying comprises:
decoding the stored digital still image frames in accordance with the predetermined compression scheme in response to the external input signal; and
converting the decoded digital still image frames into analog still image frames.

17. The method according to claim 12, wherein, in the extracting, a portion of data is extracted from a portion of the plurality of the still image frames.

18. The method according to claim 12, wherein, in the extracting, an extracting operation is performed at a predetermined time interval.

19. The method according to claim 12, wherein, the replaying comprises controlling the replayed still image frames to be scrolled and displayed on the screen.

20. An image storing and/or replaying method receiving a broadcast stream having a plurality of compressed image frames including [-frames, P-frames, and B-frames and replaying an image on a screen, the method comprising:
extracting at least one of the I-frames from the plurality of compressed image frames;
storing the extracted at least one of the I-frames; and
decoding the stored at least one of the I-frames in accordance with a predetermined decoding scheme,
wherein the extracting, storing, and decoding of the at least one of the I-frames is performed in response to an external input signal.

21. The method according to claim 20, wherein, the at least one of the I-frames is extracted at a predetermined time interval.

22. The method according to claim 20, wherein a portion of data is extracted from the at least one of the I-frames.

23. The image storing and/or reproducing apparatus of claim 1, wherein the control unit operates in response to a command input by a user.

24. The image storing and/or reproducing apparatus of claim 2, wherein the control unit controls an extracting interval of the still image extracting unit based on time information input by a user.

25. The image storing and/or reproducing apparatus of claim 24, wherein if the user does not input time information, a default time interval is set.

26. The image storing and/or reproducing apparatus of claim 2, wherein if to-be-stored still image frames exceed a storage capacity of the still image storing unit, some of the stored still image frames are removed in a first store first remove basis.

27. The image storing and/or replaying method of claim 15, wherein the predetermined compression scheme is a JPEG compression scheme.

28. The image storing and/or replaying method of claim 21, wherein a lower slice of the I-frame is extracted.

29. An image storing and/or replaying apparatus receiving a broadcast stream having a plurality of still image frames and replaying an image on a screen, the apparatus comprising:
still image storing means extracting and storing at least one of the plurality of the still image frames and replaying the stored at least one of the plurality of the still image frames; and
controlling means controlling the extracting, storing, and replaying of the at least one of the plurality of the still image frames.

30. The image storing and/or replaying apparatus according to claim 29, wherein the still image storing means comprises:
a still image extracting unit extracting the at least one of the plurality of the still image frames;
a compressing unit compressing the extracted at least one of the plurality of the still image frames; and
a still image storing unit storing the compressed at least one of the plurality of the still image frames.
